(19) United States
(12) Patent Application Publication
(10) Pub. No.: US 2024/0032144 A1
(43) Pub. Date: Jan. 25, 2024

(54) TERMINAL APPARATUS, BASE STATION APPARATUS, AND COMMUNICATION METHOD

(71) Applicant: NEC Corporation, Tokyo (JP)

(72) Inventors: Satoshi Ohara, Tokyo (JP); Yoshio Ueda, Tokyo (JP)

(73) Assignee: NEC Corporation, Tokyo (JP)

(21) Appl. No.: 18/224,416

(22) Filed: Jul. 20, 2023

(30) Foreign Application Priority Data
Jul. 25, 2022 (JP) 2022-118234

(51) Int. Cl. H04W 76/30

(52) U.S. Cl. CPC H04W 76/30

(57) ABSTRACT

Provided is a technique that enables more efficient utilization of a communication resource at the occurrence of disconnection of an interface between a base station and a core network or an interface within the core network. A process of receiving an RRC Release that is an RRC message transmitted from a base station and a process of transmitting, to the base station, an RRC Release Complete as a response to the RRC Release are carried out. The RRC Release Complete includes, as an NAS message, a PDU Session Release Complete that is a response to a PDU Session Release Command which is included, as an NAS message, in the RRC Release.

This Nonprovisional application claims priority under 35 U.S.C. § 119 on Patent Application No. 2022-118234 filed in Japan on Jul. 25, 2022, the entire contents of which are hereby incorporated by reference.

### TECHNICAL FIELD

The present invention relates to a terminal apparatus, a base station apparatus, and a communication method and relates to a terminal apparatus, a base station apparatus, and a communication method all of which enable more efficient utilization of a communication resource at the occurrence of disconnection of an interface between a base station and a core network or an interface within the core network.

### BACKGROUND ART

In 5G, a User Plane Function (UPF) of 5GC, which is a core network, and a gNB, which is a base station, are connected to each other via an N3 interface. Further, in the 5GC, the UPF and a Session Management Function (SMF) are connected to each other via an N4 interface. In a case where disconnection of the N3 interface or the N4 interface due to trouble or the like has been detected, the 5GC transmits, to the gNB, a Protocol Data Unit (PDU) Session Resource Release Command and a PDU Session Release Command. Here, the PDU Session Release Command is transmitted as a Non Access Stratum (NAS) message.

Further, Patent Literature 1 proposes configuring a UE to be able to receive, via a non-access stratum (NAS) message, an indication that an Access and Mobility management Function (AMF) of a 5GC has triggered disconnection of an active PDU session.

As defined in 3GPP TS38.413, in a case where a PDU Session Resource Release Command includes a NAS-PDU IE, a gNB transmits, to a UE, a PDU Session Release Command which is included as a NAS-PDU IE.

At this time, in a case where a PDU Session between the UE and the 5GC is one PDU Session, the gNB transmits, to the 5GC, a PDU Session Resource Release Response and a PDU Session Resource Release Complete, and then transmits a Radio Resource Control (RRC) Release to the UE to release the connection of the UE. This is because, according to the definition of 3GPP TS38.331, it is impossible to release all Data Radio Bearers (DRBs) while leaving an RRC Connection that is a Signaling Radio Bearer (SRB).

When the connection of the UE has been released, a PDU Session Release Complete that is a response to the PDU Session Release Command cannot be transmitted from the UE to the 5GC. Thus, the UE needs to transmit a Service request to re-establish RRC Connection only to transmit the PDU Session Release Complete to the 5GC.

In order to avoid inefficient RRC Connection re-establishment, a scheme using a timer at the execution of a process by the gNB may also be employed. For example, after the gNB has transmitted the PDU Session Resource Release Complete, the transmission of a UE Context Release Request is stopped until the timer expires. This allows the UE to transmit the PDU Session Release Complete to the 5GC 50 before the timer expires, and then allows RRC connection to be released.

### CITATION LIST

### Patent Literature

[Patent Literature 1]
Published Japanese Translation of PCT International Application Tokuhyo No. 2020-519195

### SUMMARY OF INVENTION

### Technical Problem

However, carrying out control using a timer slows the release of the DRB and the SRB by the time required to wait for the expiration of the timer. Thus, there has been expected a control scheme that enables more efficient utilization of a communication resource at the occurrence of disconnection of an interface between a gNB and a 5GC or an interface within the 5GC.

An example aspect of the present invention has been made in view of the above problem, and an example object thereof is to provide a technique that enables more efficient utilization of a communication resource at the occurrence of disconnection of an interface between a base station and a core network or an interface within the core network.

### Solution to Problem

A terminal apparatus in accordance with an example aspect of the present invention includes: at least one processor, the at least one processor carrying out: a process of receiving a Radio Resource Control (RRC) Release that is an RRC message transmitted from a base station; and a process of transmitting, to the base station, an RRC Release Complete as a response to the RRC Release, the RRC Release Complete including, as a Non Access Stratum (NAS) message, a PDU Session Release Complete that is a response to a PDU Session Release Command which is included, as an NAS message, in the RRC Release.

A communication method in accordance with an example aspect of the present invention is a communication method for a terminal apparatus that communicates with a base station, the communication method including: receiving a Radio Resource Control (RRC) Release that is an RRC message transmitted from the base station; and transmitting, to the base station, an RRC Release Complete as a response to the RRC Release, the RRC Release Complete including, as a Non Access Stratum (NAS) message, a PDU Session Release Complete that is a response to a PDU Session Release Command which is included, as an NAS message, in the RRC Release.

A program in accordance with an example aspect of the present invention causes a computer to function as a terminal apparatus, the terminal apparatus including: a reception means that receives a Radio Resource Control (RRC) Release that is an RRC message transmitted from a base station; and a transmission means that transmits, to the base station, an RRC Release Complete as a response to the RRC Release, the RRC Release Complete including, as a Non Access Stratum (NAS) message, a PDU Session Release Complete that is a response to a PDU Session Release Command which is included, as an NAS message, in the RRC Release.

A base station apparatus in accordance with an example aspect of the present invention includes: at least one processor, the at least one processor carrying out: a process of receiving a Next Generation Application Protocol (NGAP) message transmitted from a core network, the NGAP message including a PDU Session Release Command as a Non Access Stratum (NAS) message; and a first transmission process of transmitting, to the core network, a UE Context Release Complete that is an NGAP message, the UE Context Release Complete including, as an NAS message, the PDU Session Release Complete that has been received, as a response to the PDU Session Release Command, from a terminal apparatus.

A communication method in accordance with an example aspect of the present invention is a communication method for a base station that communicates with a core network and a terminal apparatus, the communication method including: receiving a Next Generation Application Protocol (NGAP) message transmitted from a core network, the NGAP message including a PDU Session Release Command as a Non Access Stratum (NAS) message; and transmitting, to the core network, a UE Context Release Complete that is an NGAP message, the UE Context Release Complete including, as an NAS message, the PDU Session Release Complete that has been received, as a response to the PDU Session Release Command, from the terminal apparatus.

A program in accordance with an example aspect of the present invention causes a computer to function as a base station apparatus, the base station apparatus including: a reception means that receives a Next Generation Application Protocol (NGAP) message transmitted from a core network, the NGAP message including a PDU Session Release Command as a Non Access Stratum (NAS) message; and a first transmission means that transmits, to the core network, a UE Context Release Complete that is an NGAP message, the UE Context Release Complete including, as an NAS message, the PDU Session Release Complete that has been received, as a response to the PDU Session Release Command, from a terminal apparatus.

### Advantageous Effects of Invention

According to an example aspect of the present invention, it is possible to more efficiently utilize communication resources at the occurrence of disconnection of an interface between the base station and the core network or an interface within the core network.

### BRIEF DESCRIPTION OF DRAWINGS

FIG. 1 is a block diagram illustrating a configuration example of a terminal apparatus 10 in accordance with a first example embodiment of the present invention.

FIG. 2 is a flowchart illustrating a flow of a communication method for the terminal apparatus 10 in accordance with the first example embodiment of the present invention.

FIG. 3 is a block diagram illustrating a configuration example of a base station apparatus 30 in accordance with the first example embodiment.

FIG. 4 is a flowchart illustrating a flow of a communication method for the base station apparatus 30 in accordance with the first example embodiment.

FIG. 5 is a diagram illustrating an example of a connection mode of the terminal apparatus 10, the base station apparatus 30, and a core network 50 in accordance with the first example embodiment.

FIG. 6 is an arrow chart illustrating an example of a control scheme for communications between a UE 10, a gNB 30, and a 5GC 50 in a case where disconnection of an N3 interface or an N4 interface has been detected.

FIG. 7 is a diagram illustrating control relating to an RRC Connection Release in 3GPP TS38.331.

FIG. 8 is a diagram illustrating control relating to an RRC Connection Release in accordance with the first example embodiment.

FIG. 9 is a view illustrating a description of ASN. 1 that defines an RRC Release message in 3GPP TS38.331 6.2.2.

FIG. 10 is a view illustrating a description of ASN.1 that defines an RRC Release message in accordance with the first example embodiment.

FIG. 11 is a view illustrating a table that defines the structure of a UE Context Release Complete in 3GPP TS38.413 9.2.2.6.

FIG. 12 is a view illustrating a table that defines the structure of a UE Context Release Complete in accordance with the first example embodiment.

FIG. 13 is an arrow chart illustrating an example of a communication control scheme in accordance with a second example embodiment.

FIG. 14 is a view illustrating a table that defines the structure of a UE Context Release Command in 3GPP TS38.413 9.2.2.5.

FIG. 15 is a view illustrating a table that defines the structure of a UE Context Release Command in accordance with the second example embodiment.

FIG. 16 is an arrow chart illustrating an example of a communication control scheme in accordance with a third example embodiment.

FIG. 17 is an arrow chart illustrating an example of a communication control scheme in accordance with a fourth example embodiment.

FIG. 18 is an arrow chart illustrating an SMS transmission scheme that is defined in 3GPP TS23.502 4.13.3.3.

FIG. 19 is a diagram illustrating a configuration example of a computer that executes instructions of a program which is software realizing individual functions.

### DESCRIPTION OF EMBODIMENTS

### First Example Embodiment

A first example embodiment of the present invention will be described in detail with reference to the drawings.

<Overview of Terminal Apparatus 10 and Communication Method Therefor and Base Station Apparatus 30 and Communication Method Therefor>

A terminal apparatus 10 in accordance with the present example embodiment is, schematically speaking, an apparatus that communicates with a base station apparatus 30 connected thereto via a network.

As an example, the terminal apparatus 10 is an apparatus, such as a smart phone, a mobile phone, or a personal computer, that communicates with the base station apparatus 30 connected thereto via a wireless network. Alternatively, the terminal apparatus 10 may be a sensor apparatus or the like used in IoT.

As an example, the base station apparatus 30 functions as an access point to a core network 50 such as a 5GC. The base station apparatus 30 has a communication area corresponding to a predetermined distance, and the terminal apparatus 10 located within the communication area is connected to a wireless base station. The terminal apparatus 10 can access the core network 50 through the base station apparatus 30 and communicate with, for example, a server in a data network connected to the core network 50.

The terminal apparatus 10 of the present example embodiment, as an example, includes:
a reception means that receives an RRC Release that is an Radio Resource Control (RRC) message transmitted from a base station; and
a transmission means that transmits, to the base station, an RRC Release Complete as a response to the RRC Release,
the RRC Release Complete including, as an NAS message, a PDU Session Release Complete that is a response to a Protocol Data Unit (PDU) Session Release Command which is included, as an NAS message, in the RRC Release.

The base station apparatus 30 of the present example embodiment, as an example, includes:
a reception means that receives a Next Generation Application Protocol (NGAP) message transmitted from a core network, the NGAP message including a PDU Session Release Command as a Non Access Stratum (NAS) message; and
a first transmission means that transmits, to the core network, a UE Context Release Complete that is an NGAP message, the UE Context Release Complete including, as an NAS message, the PDU Session Release Complete that is a response to the PDU Session Release Command.

The RRC message is a message that is transmitted and received between the terminal apparatus 10 and the base station apparatus 30. The NGAP message is a message that is transmitted and received between the base station apparatus 30 and the core network 50. The NAS is a function layer between the terminal apparatus 10 and the core network 50. The NAS message is a message that is transmitted and received between the terminal apparatus 10 and the core network 50 through the base station apparatus 30.

<Configuration of Terminal Apparatus 10>

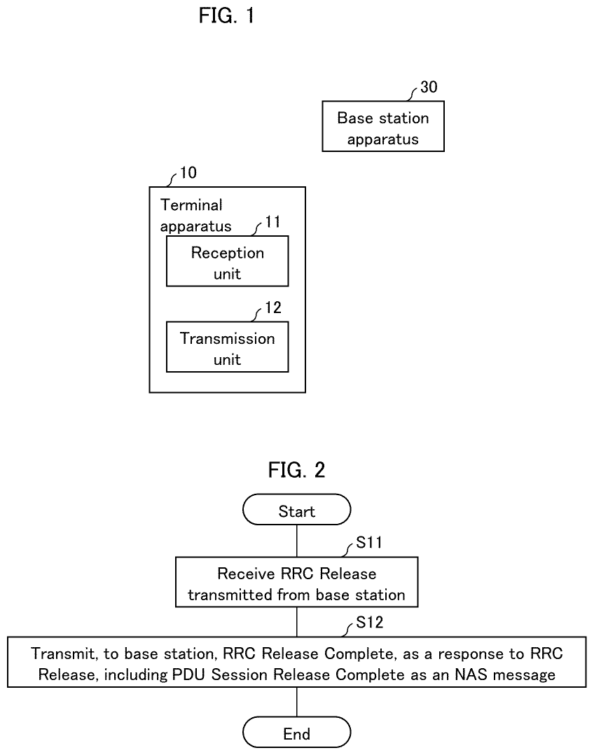

A configuration of the terminal apparatus 10 in accordance with the present example embodiment will be described with reference to FIG. 1. FIG. 1 is a block diagram illustrating a configuration example of the terminal apparatus 10 in accordance with the present example embodiment. As illustrated in FIG. 1, the terminal apparatus 10 includes a reception unit 11 that receives an RRC Release that is an RRC message transmitted from the base station apparatus 30. Further, the terminal apparatus 10 has a transmission unit 12 that transmits an RRC Release Complete as a response to the RRC Release. The reception unit 11 is configured to realize the reception means in the present example embodiment. The transmission unit 12 is configured to realize the transmission means in the present example embodiment.

<Flow of Communication Method for Terminal Apparatus 10>

A flow of a communication method for the terminal apparatus 10 in accordance with the present example embodiment will be described with reference to FIG. 2. FIG. 2 is a flowchart illustrating a flow of a communication method for the terminal apparatus 10 in accordance with the present example embodiment. As illustrated in FIG. 2, in step S11, the terminal apparatus 10 receives an RRC Release transmitted from a base station. Further, in step S12, the terminal apparatus 10 transmits, to the base station, an RRC Release Complete, as a response to the RRC Release, including a PDU Session Release Complete as an NAS message. Here, the PDU Session Release Complete is a response to a PDU Session Release Command which is included as an NAS message in the RRC Release transmitted from the base station.

<Configuration of Base Station Apparatus 30>

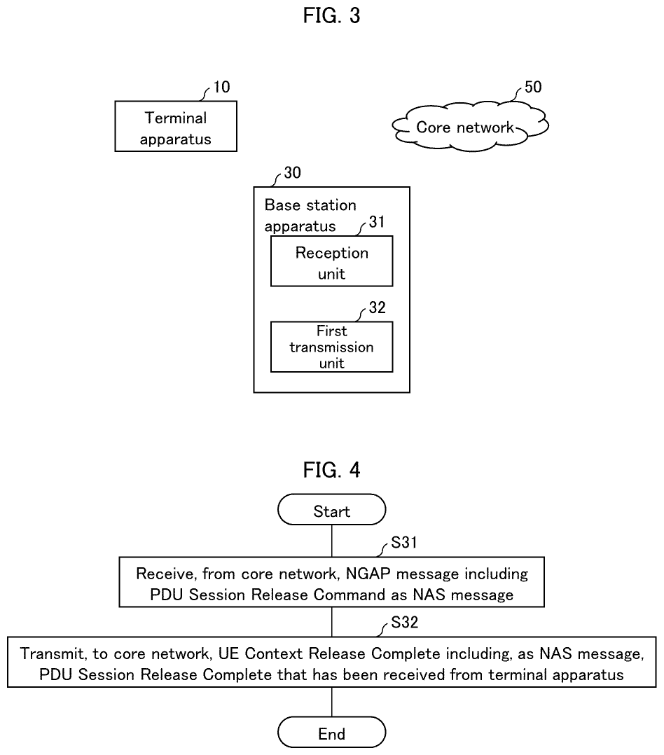

A configuration of the base station apparatus 30 in accordance with the present example embodiment will be described with reference to FIG. 3. FIG. 3 is a block diagram illustrating a configuration example of the base station apparatus 30 in accordance with the present example embodiment. As illustrated in FIG. 3, the base station apparatus 30 includes a reception unit 31 that receives the NGAP message transmitted from the core network 50, the NGAP message including the PDU Session Release Command as the NAS message. Further, the base station apparatus 30 includes a first transmission unit 32 that transmits, to the core network 50, a UE Context Release Complete that is an NGAP message, the UE Context Release Complete including, as an NAS message, a PDU Session Release Complete that has been received, as a response to the PDU Session Release Command, from the terminal apparatus 10. The first transmission unit 32, in a case where an NGAP message transmitted from the core network 50 and including a PDU Session Release Command as NAS-PDU IE has been received, transmits the RRC Release to the terminal apparatus 10.

The reception unit 31 is configured to realize the reception means in the present example embodiment. The first transmission unit 32 is configured to realize the first transmission means in the present example embodiment.

<Flow of Communication Method for Base Station Apparatus 30>

A flow of a communication method for the base station apparatus 30 in accordance with the present example embodiment will be described with reference to FIG. 4. FIG. 4 is a flowchart illustrating a flow of a communication method for the base station apparatus 30 in accordance with the present example embodiment. As illustrated in FIG. 4, in step S31, the base station apparatus 30 receives, from the core network, the NGAP message including the PDU Session Release Command as the NAS message. Further, in step S32, the base station apparatus 30 transmits, to the core network 50, the UE Context Release Complete including, as the NAS message, the PDU Session Release Complete that has been received from the terminal apparatus 10.

When the PDU Session Release Complete having been transmitted from the base station apparatus 30 is received by the core network 50, a PDU Session used for the communication between the terminal apparatus 10 and a server or the like within the data network is released, and the DRB and the SRB that have been established are released.

<Overview of Communication System>

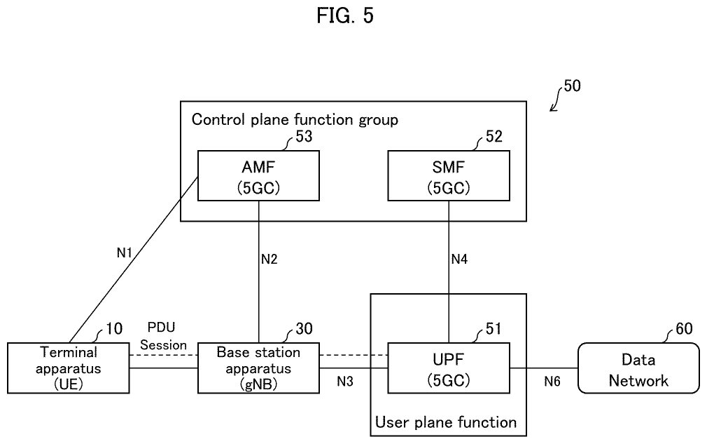

FIG. 5 is a diagram illustrating an example of a connection mode of the terminal apparatus 10, the base station apparatus 30, and the core network 50 in accordance with the present example embodiment. Note that the terminal apparatus 10 is also referred to as a UE. The base station apparatus 30 is also referred to as a gNB. The core network 50 is also referred to as a 5GC.

A User Plane Function (UPF) 51, a Session Management Function (SMF) 52, and an Access and Mobility management Function (AMF) 53 illustrated in FIG. 5 constitute a 5GC. In the example of FIG. 5, the UPF 51 is connected to a Data Network (DN) 60.

In the example of FIG. 5, a PDU Session is established between the UE 10 and the UPF 51. The UE 10 establishes a PDU Session with the UPF 51 that is connected to the DN 60, in communicating with the server within the DN 60. The UPF 51 is an apparatus that realizes a user plane function of the 5GC, and is an apparatus that relays and terminates a user plane of a PDU Session. The SMF 52 and AMF 53 are apparatuses that realize a control plane function of the 5GC. The SMF 52 is an apparatus that manages a PDU Session, and is connected to the UPF 51. The AMF 53 mainly carries out the management of the mobility.

An interface relating to the connection between the UE10 and the AMF 53 is referred to as an N1 interface. An interface relating to the connection between the gNB 30 and the AMF 53 is referred to as an N2 interface. An interface relating to the connection between the gNB 30 and the UPF 51 is referred to as an N3 interface. An interface relating to the connection between the UPF 51 and the SMF 52 is referred to as an N4 interface. An interface relating to the connection between the UPF 51 and the DN 60 is referred to as an N6 interface.

According to the definition of 3GPP TS38.413, for example, in a case where trouble has occurred and disconnection of the N3 interface or the N4 interface has been detected, the 5GC 50 transmits, to the gNB 30, a PDU Session Resource Release Command and a PDU Session Release Command. Here, the PDU Session Release Command is transmitted as an NAS message.

At this time, in a case where the PDU Session between the UE 10 and the 5GC 50 is one PDU Session, the gNB 30 transmits, to the 5GC 50, a PDU Session Resource Release Response and a PDU Session Resource Release Complete, and then transmits a Radio Resource Control (RRC) Release to the UE 10 to release the connection of the UE. That is, an RRC connection between the UE 10 and the gNB 30 is released. This is because, according to the definition of 3GPP TS38.331, it is impossible to release all Data Radio Bearers (DRBs) while leaving an RRC Connection that is a Signaling Radio Bearer (SRB).

When the connection of the UE 10 has been released, data cannot be transmitted from the UE 10 to the 5GC 50. Thus, the UE 10 cannot transmit, to the 5GC 50, a PDU Session Release Complete that is a response to the PDU Session Release Command. In this case, the UE 10 needs to transmit a Service request to re-establish the RRC Connection only to transmit the PDU Session Release Complete to the 5GC.

In order to avoid inefficient RRC Connection re-establishment, a scheme using a timer at the execution of a process by the gNB 30 may also be employed. For example, after the gNB 30 has transmitted the PDU Session Resource Release Complete, the transmission of a UE Context Release Request is stopped until the timer expires. This allows the UE 10 to transmit the PDU Session Release Complete to the 5GC 50 before the timer expires, and then allows RRC connection to be released.

<Control Scheme Using Timer>

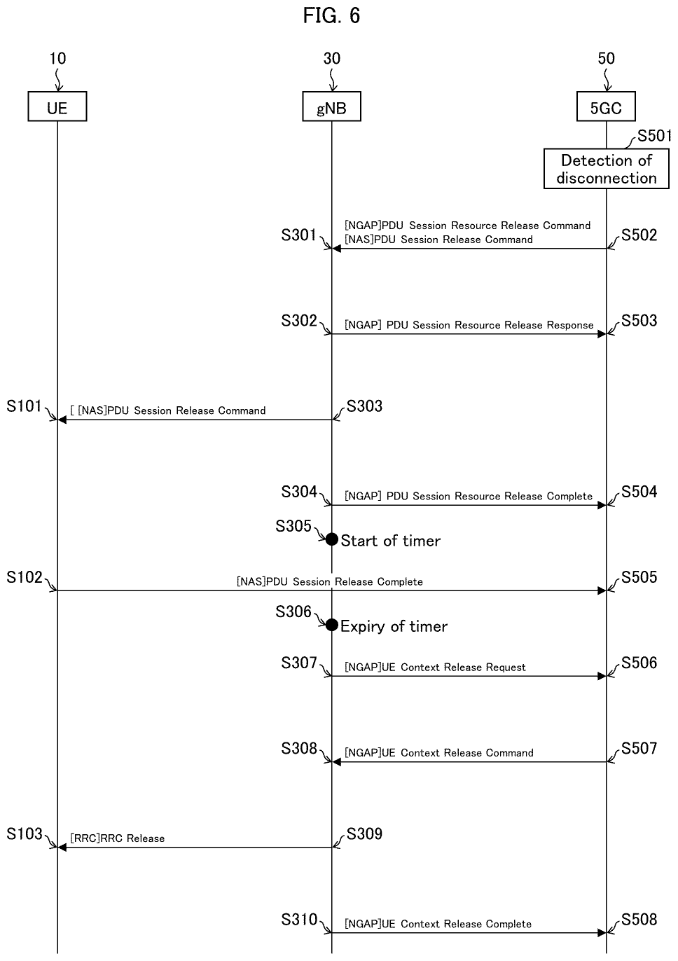

Here, a control scheme using a timer will be described for comparison with a control scheme of the present example embodiment. FIG. 6 is an arrow chart illustrating an example of a control scheme for communications between the UE 10, the gNB 30, and the 5GC 50 in a case where disconnection of the N3 interface or the N4 interface has been detected. This control scheme is one example of a control scheme for avoiding inefficient RRC Connection re-establishment, and is a control scheme using a timer. Note that, in FIG. 5, a message to be transmitted and received is indicated by an arrow. [NGAP], [NAS], and [RRC] shown at the beginning of each message indicate that the messages are an NGAP message, an NAS message, and an RRC message, respectively.

In step S501, the 5GC 50 detects disconnection of the N3 interface or the N4 interface. Note, here, that it is assumed that the 5GC 50 has a detection unit which detects disconnection of the N3 interface or the N4 interface.

In step S502, the 5GC 50 transmits a PDU Session Resource Release Command and a PDU Session Release Command to the gNB 30, and, in step S301, the gNB 30 receives the PDU Session Resource Release Command and the PDU Session Release Command. Here, the PDU Session Release Command is transmitted as the NAS message.

In step S302, the gNB 30 transmits a PDU Session Resource Release Response to the 5GC 50, and, in step S503, the 5GC 50 receives the PDU Session Resource Release Response.

In step S303, the gNB 30 transmits a PDU Session Release Command to the UE 10, and, in step S101, the UE 10 receives the PDU Session Release Command.

In step S304, the gNB 30 transmits a PDU Session Resource Release Complete to the 5GC 50, and, in step S504, the 5GC 50 receives the PDU Session Resource Release Complete. After the process in step S304, in step S305, a timer of the gNB 30 is started. In step S306, the timer expires.

Before the timer expires after the timer has been started, in step S102, the UE 10 transmits a PDU Session Release Complete to the 5GC 50, and, in step S505, the 5GC 50 receives the PDU Session Release Complete.

In step S307, the gNB 30 transmits a UE Context Release Request to the 5GC 50, and, in step S506, the 5GC 50 receives the UE Context Release Request.

In step S507, the 5GC 50 transmits a UE Context Release Command to the gNB 30, and, in step S308, the gNB 30 receives the UE Context Release Command.

In step S309, the gNB 30 transmits an RRC Release to the UE 10, and, in step S103, the UE 10 receives the RRC Release.

In step S310, the gNB 30 transmits a UE Context Release Complete to the 5GC 50, and, in step S508, the 5GC 50 receives the UE Context Release Complete. This releases a PDU Session used for communications between the UE 10 and the server of the DN 60 and releases the DRB and the SRB that have been established.

Thus, the control scheme using the timer enables the UE 10 to transmit the PDU Session Release Complete to the 5GC without re-establishing an RRC Connection. However, carrying out control using a timer slows the release of the DRB and the SRB by the time required to wait for the expiration of the timer.

Thus, disclosed in the present example embodiment is a technique in which the UE 10 transmits the PDU Session Release Complete to the 5GC without using a timer and without re-establishing an RRC Connection.

<Addition of RRC Release Complete>

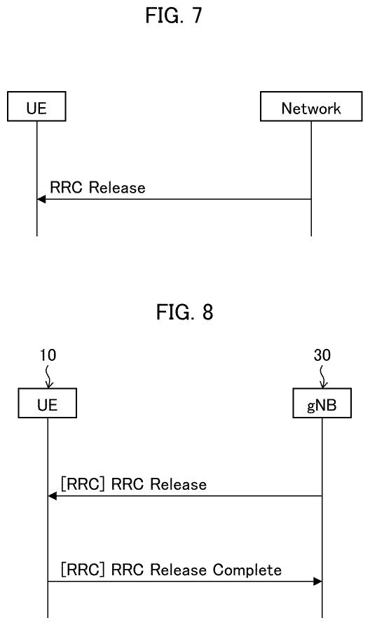

According to 3GPP TS38.331 5.3.8, release of RRC connection (RRC Connection Release) is carried out by transmitting an RRC Release from the gNB 30 to the UE 10. FIG. 7 is a diagram illustrating control relating to the RRC Connection Release in 3GPP TS38.331. FIG. 7 illustrates that an RRC Release is transmitted from a Network (in this case, corresponding to a gNB) to a UE.

In the present example embodiment, an RRC Release Complete that is an RRC message is added as a response to an RRC Release. FIG. 8 is a diagram illustrating control relating to an RRC Connection Release in accordance with the present example embodiment. FIG. 8 illustrates that, after an RRC Release has been transmitted from the gNB 30 to the UE 10, an RRC Release Complete is transmitted from the UE 10 to the gNB 30.

<Extension of RRC Release>

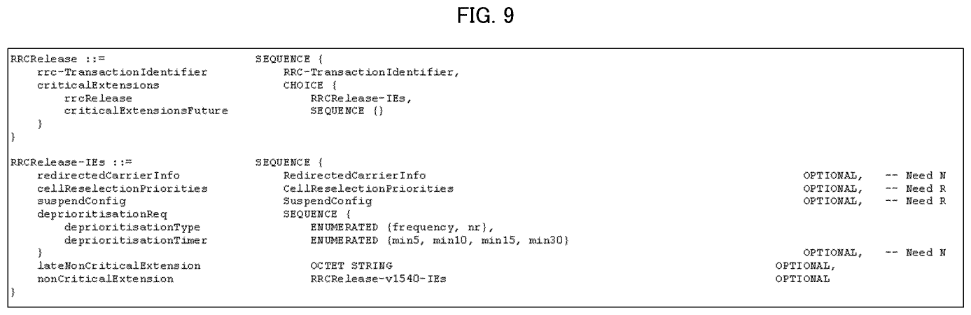

FIG. 9 is a view illustrating a description of Abstract Syntax Notation One (ASN. 1) that defines an RRC Release message in 3GPP TS38.331 6.2.2 Message definitions.

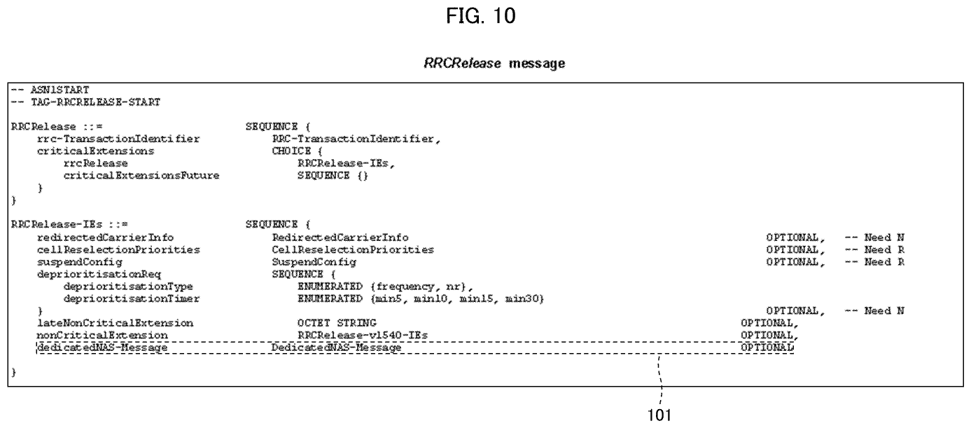

In the present example embodiment, an RRC Release message is extended to allow an NAS message to be transmitted. More specifically, Information Element (IE) for NAS message is added to the RRC Release message. FIG. 10 is a view illustrating a description of ASN.1 that defines an RRC Release message in accordance with the present example embodiment. In FIG. 10, an IE of dedicated NAS-Message is indicated in a part enclosed by a frame line 101. In this way, in transmitting the RRC Release from the gNB 30 to the UE 10, it is possible to cause a PDU Session Release Command to be included as an NAS message in the RRC Release.

Note that an RRC Release Complete is also configured to have an IE for an NAS message in the same manner as the RRC Release. Therefore, in transmitting the RRC Release Complete from the UE 10 to the gNB 30, it is possible to include a PDU Session Resource Release Complete as an NAS message.

<Extension of UE Context Release Complete>

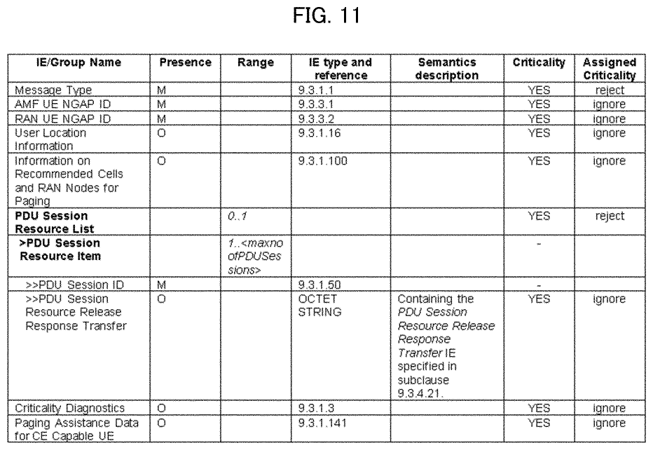

FIG. 11 is a view illustrating a table that defines the structure of a UE Context Release Complete in 3GPP TS38.413 9.2.2.6. In this table, IE/Group NAME indicates the name of an IE or a group. Presence indicates whether an IE is mandatory (M) or optional (O). Range indicates the upper and lower limits of the number of IEs. IE type and reference indicates the type of an IE or a part to which reference is made within a standard. In Semantics description, supplementary explanations on an IE are described as required. Criticality indicates whether Assigned Criticality is specified or not. Assigned Criticality indicates an action, such as ignoring (Ignore) or rejection (Reject), to be taken in a case where there is no IE in a message.

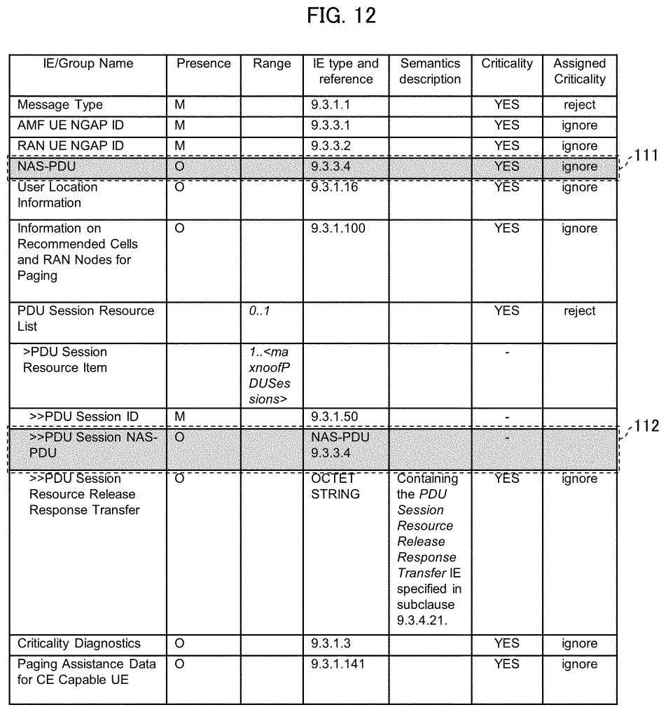

FIG. 12 is a view illustrating a table that defines the structure of a UE Context Release Complete in accordance with the present example embodiment. Unlike the case of FIG. 11, FIG. 12 additionally includes descriptions of parts enclosed by frame lines 111 and 112. In the part enclosed by the frame line 111, an IE called NAS-PDU is defined. Further, in the part enclosed by the frame line 112, an IE called PDU Session NAS-PDU is defined. This IE is an IE in a group called PDU Session Resource Item. In this way, in transmitting the UE Context Release Complete from the gNB 30 to the 5GC 50, it is possible to cause a PDU Session Release Complete to be included as an NAS message in the UE Context Release Complete.

<Effect of First Example Embodiment>

As described above, according to the present example embodiment, the PDU Session Release Command and the PDU Session Release Complete are transmitted and received as NAS messages. Thus, in a case where disconnection of the N3 interface or the N4 interface has been detected, it is possible to avoid inefficient RRC Connection re-establishment.

Further, since the PDU Session Release Complete is transmitted as an NAS message, it is possible to transmit the PDU Session Release Complete concurrently with release of an RRC Connection. Therefore, it is possible to transmit the PDU Session Release Complete from the UE 10 to the 5GC 50 without using a timer. Thus, it is possible to quickly release the DRB and the SRB.

As described above, according to the present example embodiment, it is possible to more efficiently utilize a communication resource at the occurrence of disconnection of an interface between the base station apparatus 30 and the core network 50 or an interface within the core network 50.

### Second Example Embodiment

Next, the details of the control scheme of communications between the terminal apparatus 10, the base station apparatus 30, and the core network 50 in accordance with the above-described first example embodiment will be described.

<Control Scheme of the Present Example Embodiment>

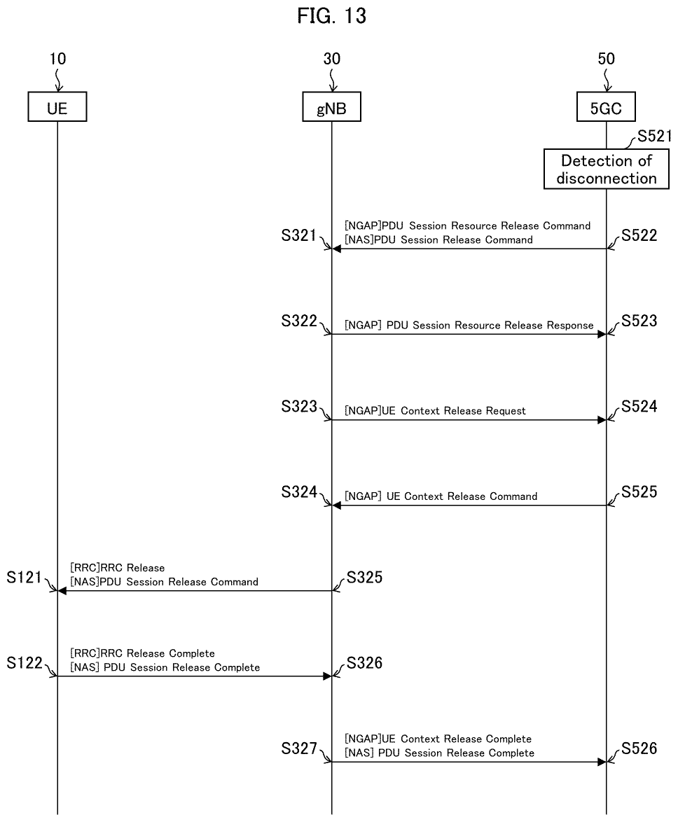

FIG. 13 is an arrow chart illustrating another example of a control scheme for communications between the UE 10, the gNB 30, and the 5GC 50 in a case where disconnection of the N3 interface or the N4 interface has been detected. Note that, in FIG. 13, messages to be transmitted and received are indicated by arrows. [NGAP], [NAS], and [RRC] shown at the beginning of each message indicate that the messages are an NGAP message, an NAS message, and an RRC message, respectively.

The control scheme of FIG. 13 is one example of a control scheme that avoids inefficient RRC Connection re-establishment. Further, as described in the first example embodiment, carrying out the addition of an RRC Release Complete, the extension of an RRC Release, and the extension of a UE Context Release Complete is a prerequisite for the implementation of the control scheme of FIG. 13. Unlike the control scheme described above with reference to FIG. 6, the control scheme of FIG. 13 does not use a timer.

In step S521, the 5GC detects disconnection of the N3 interface or the N4 interface. Note, here, that it is assumed that the 5GC 50 has a detection unit which detects disconnection of the N3 interface or the N4 interface.

In step S522, the 5GC 50 transmits a PDU Session Resource Release Command, which is an NGAP message, and a PDU Session Release Command to the gNB 30, and, in step S321, the gNB 30 receives the PDU Session Resource Release Command and the PDU Session Release Command. Here, the PDU Session Release Command is transmitted as an NAS message.

Thus, the NGAP message including the PDU Session Release Command as the NAS message is transmitted from the 5GC 50 in a case where disconnection of the N3 interface has been detected or in a case where disconnection of the N4 interface has been detected. Further, the NGAP message including the PDU Session Release Command as the NAS message is a PDU Session Resource Release Command.

In step S322, the gNB 30 transmits a PDU Session Resource Release Response to the 5GC 50, and, in step S523, the 5GC 50 receives the PDU Session Resource Release Response.

In step S323, the gNB 30 transmits a UE Context Release Request to the 5GC 50, and, in step S524, the 5GC 50 receives the UE Context Release Request.

In step S525, the 5GC 50 transmits a UE Context Release Command to the gNB 30, and, in step S324, the gNB 30 receives the UE Context Release Command.

In step S325, the gNB 30 transmits an RRC Release to the UE 10, and, in step S121, the UE 10 receives the RRC Release. Extending the RRC Release as described above with reference to FIG. 10 enables an NAS message to be included in the RRC Release. That is, the RRC Release transmitted in step S325 includes the PDU Session Release Command as the NAS message. In this way, the PDU Session Release Command having been included as the NAS message in the PDU Session Resource Release Command that is the NGAP message having been received in step S321 is transmitted from the gNB 30 to the UE10.

In addition, as described above, when the gNB 30 has further received the UE Context Release Command that is the NGAP message which is transmitted from the 5GC 50, the gNB 30 transmits, to the UE 10, the RRC Release including the PDU Session Release Command as the NAS message.

Furthermore, the RRC Release including the PDU Session Release Command as the NAS message is transmitted from the gNB 30, in a case where disconnection of the N3 interface has been detected in step S521 or in a case where disconnection of the N4 interface has been detected in step S521.

In step S122, the UE 10 transmits an RRC Release Complete to the gNB 30, and, in step S326, the gNB 30 receives the RRC Release Complete. By adding the RRC Release Complete as described above with reference to FIG. 8, the RRC Release Complete is transmitted, as a response to the RRC Release, from the UE 10. In addition, the RRC Release Complete transmitted in step S122 includes the PDU Session Release Complete as the NAS message. This PDU Session Release Complete is a response to the PDU Session Release Command having been transmitted in step S522.

In step S327, the gNB 30 transmits a UE Context Release Complete to the 5GC 50, and, in step S526, the 5GC 50 receives the UE Context Release Complete. This releases a PDU Session used for communications between the UE 10 and the server of the DN 60 and releases the DRB and the SRB that have been established.

Thus, the gNB 30 transmits, to the 5GC 50, the UE Context Release Complete including the PDU Session Release Complete as the NAS message, in a case where the gNB 30 has received, from the UE 10, the RRC Release Complete that is a response to the RRC Release, the RRC Release Complete including, as the NAS message, the PDU Session Release Complete that is a response to the PDU Session Release Command.

<Effect of Second Example Embodiment>

Thus, according to the present example embodiment, in a case where disconnection of the N3 interface or the N4 interface has been detected, it is possible to avoid inefficient RRC Connection re-establishment. In addition, since no timer is used, it is possible to release the DRB and the SRB without waiting for the expiration of the timer. Furthermore, for example, when compared to the control scheme of FIG. 6, the number of messages transmitted and received before the DRB and SRB are released can be reduced, and the DRB and SRB can be released more quickly.

As described above, according to the present example embodiment, it is possible to more efficiently utilize a communication resource at the occurrence of disconnection of an interface between the base station and the core network or an interface within the core network.

### Third Example Embodiment

In the first and second example embodiments, carrying out the addition of an RRC Release Complete, the extension of an RRC Release, and the extension of a UE Context Release Complete has been described. However, extension of a message may be further carried out in order to realize a simpler control scheme.

In the present example embodiment, a UE Context Release Command is expanded, in addition to the addition of an RRC Release Complete, the extension of an RRC Release, and the extension of a UE Context Release Complete. The UE Context Release Command is, for example, an NGAP message which is transmitted from the 5GC 50 to the gNB 30 in step S525 of FIG. 13.

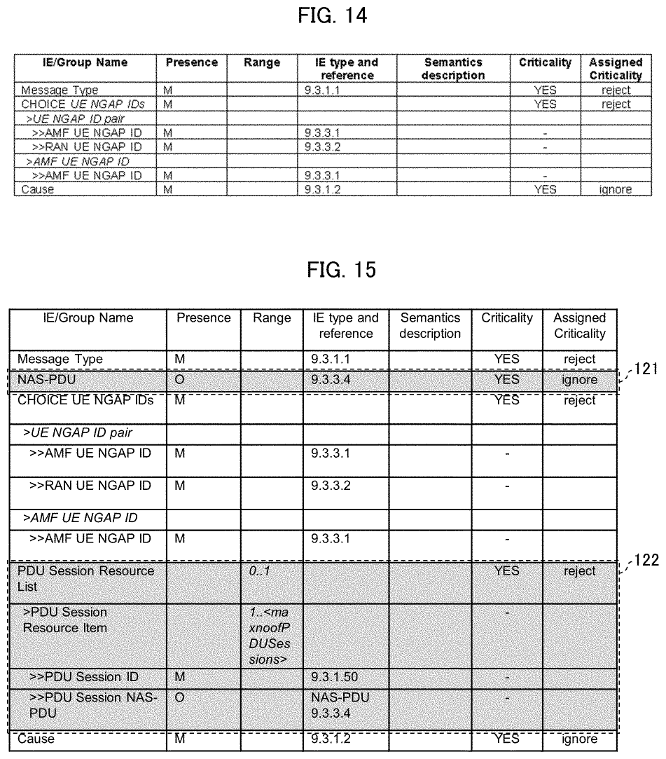

FIG. 14 is a view illustrating a table that defines the structure of a UE Context Release Command in 3GPP TS38.413 9.2.2.5.

FIG. 15 is a view illustrating a table that defines the structure of a UE Context Release Command in accordance with the present example embodiment. In FIG. 15, descriptions of parts enclosed by frame lines 121 and 122 have been added with respect to FIG. 14.

In the part enclosed by the frame line 121, an IE called NAS-PDU is defined. Further, in the part enclosed by the frame line 122, a group called PDU Session Resource List is defined. The PDU Session Resource List includes a group called PDU Session Resource item. The PDU Session Resource item is constructed by IEs called PDU Session ID and PDU Session NAS-PDU.

In this way, in transmitting the UE Context Release Command from the 5GC 50 to the gNB 30, it is possible to cause a PDU Session Release Command to be included as an NAS message in the UE Context Release Command.

<Control Scheme of the Present Example Embodiment>

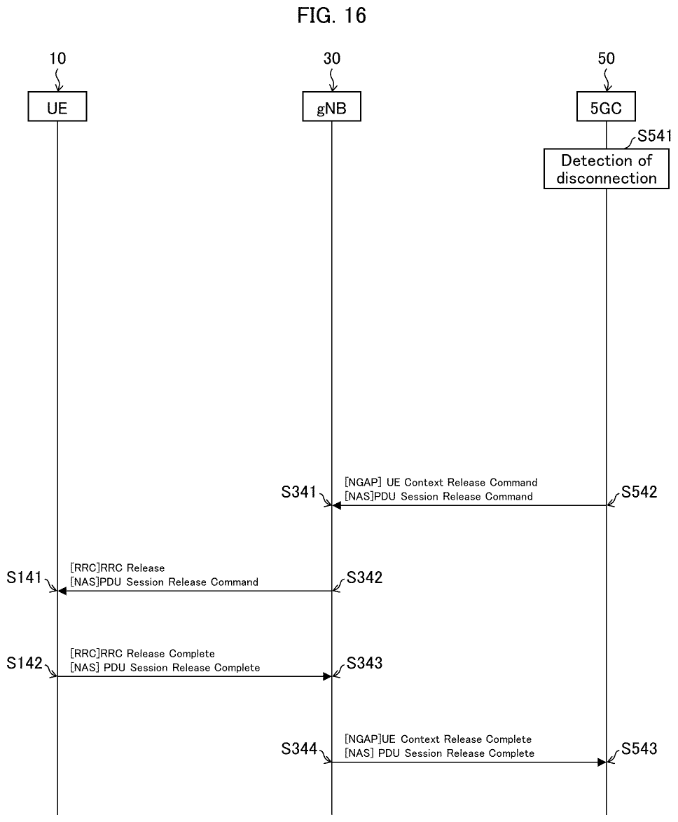

FIG. 16 is an arrow chart illustrating still another example of a control scheme for communications between the UE 10, the gNB 30, and the 5GC 50 in a case where disconnection of the N3 interface or the N4 interface has been detected. Note that, in FIG. 16, messages to be transmitted and received are indicated by arrows. [NGAP], [NAS], and [RRC] shown at the beginning of each message indicate that the messages are an NGAP message, an NAS message, and an RRC message, respectively.

The control scheme of FIG. 16 is one example of a control scheme that avoids inefficient RRC Connection re-establishment. Further, carrying out extension of a UE Context Release Command, in addition to the addition of an RRC Release Complete, the extension of an RRC Release, and the extension of a UE Context Release Complete, is a prerequisite for the implementation of the control scheme of FIG. 16. Unlike the control scheme described above with reference to FIG. 6, the control scheme of FIG. 16 does not use a timer.

In step S541, the 5GC detects disconnection of the N3 interface or the N4 interface. Note, here, that it is assumed that the 5GC 50 has a detection unit which detects disconnection of the N3 interface or the N4 interface.

In step S542, the 5GC 50 transmits, to the gNB 30, a UE Context Release Command that is an NGAP message, and, in step S341, the gNB 30 receives the UE Context Release Command. Extending the UE Context Release Command as described above with reference to FIG. 15 enables an NAS message to be included in the UE Context Release Command. That is, the UE Context Release Command transmitted in step S542 includes the PDU Session Release Command as the NAS message.

Thus, the NGAP message including the PDU Session Release Command as the NAS message is the UE Context Release Command.

In step S342, the gNB 30 transmits an RRC Release to the UE 10, and, in step S141, the UE 10 receives the RRC Release. Extending the RRC Release as described above with reference to FIG. 10 enables an NAS message to be included in the RRC Release. That is, the RRC Release transmitted in step S342 includes the PDU Session Release Command as the NAS message. In this way, the PDU Session Release Command having been included as the NAS message in the UE Context Release Command that is the NGAP message having been received in step S341 is transmitted from the gNB 30 to the UE10.

In addition, the RRC Release including the PDU Session Release Command as the NAS message is transmitted from the gNB 30, in a case where disconnection of the N3 interface has been detected in step S541 or in a case where disconnection of the N4 interface has been detected in step S541.

In step S142, the UE 10 transmits an RRC Release Complete to the gNB 30, and, in step S343, the gNB 30 receives the RRC Release Complete. By adding the RRC Release Complete as described above with reference to FIG. 8, the RRC Release Complete is transmitted, as a response to the RRC Release, from the UE. In addition, the RRC Release Complete transmitted in step S142 includes the PDU Session Release Complete as the NAS message. This PDU Session Release Complete is a response to the PDU Session Release Command having been transmitted in step S542.

In step S344, the gNB 30 transmits a UE Context Release Complete to the 5GC 50, and, in step S543, the 5GC 50 receives the UE Context Release Complete. This releases a PDU Session used for communications between the UE 10 and the server of the DN 60 and releases the DRB and the SRB that have been established.

Thus, the gNB 30 transmits, to the 5GC 50, the UE Context Release Complete including the PDU Session Release Complete as the NAS message, in a case where the gNB 30 has received, from the UE 10, the RRC Release Complete that is a response to the RRC Release, the RRC Release Complete including, as the NAS message, the PDU Session Release Complete that is a response to the PDU Session Release Command.

<Effect of Third Example Embodiment>

Thus, according to the present example embodiment, in a case where disconnection of the N3 interface or the N4 interface has been detected, it is possible to avoid inefficient re-establishment of an RRC Connection. In addition, since no timer is used, it is possible to release the DRB and the SRB without waiting for the expiration of the timer. Furthermore, when compared to the control scheme of FIG. 6, the number of messages transmitted and received before the DRB and SRB are released can be reduced, and the DRB and SRB can be released more quickly. In addition, even when compared to the control scheme of FIG. 13, the number of messages transmitted and received before the DRB and SRB are released can be reduced. Therefore, the DRB and the SRB can be released even more quickly, and a simpler control scheme can be realized.

### Fourth Example Embodiment

In the third example embodiment, an example of a case where disconnection of the N3 interface or the N4 interface is detected by the 5GC 50 has been described. Alternatively, disconnection of the N3 interface may be detected by the gNB 30.

<Control Scheme of the Present Example Embodiment>

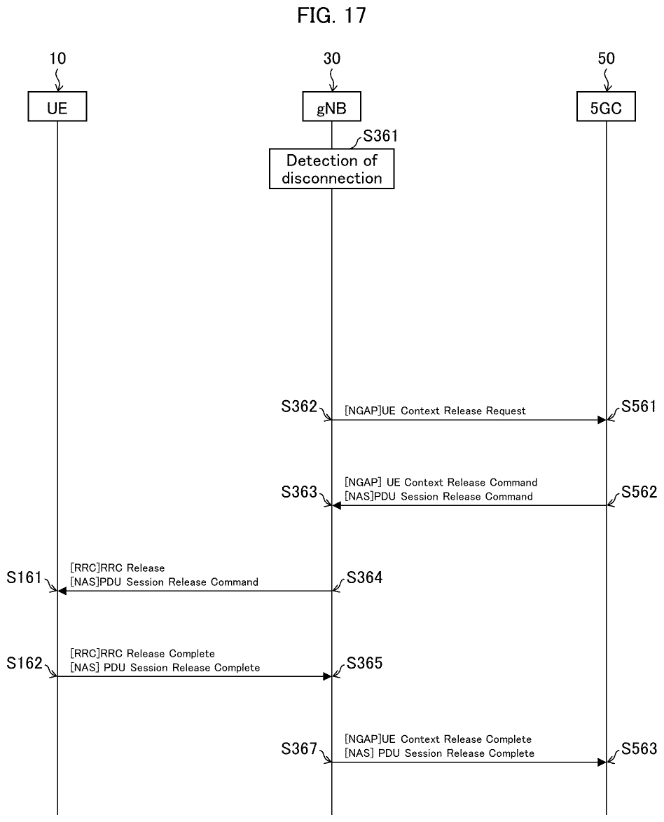

FIG. 17 is an arrow chart illustrating yet another example of a control scheme for communications between the UE 10, the gNB 30, and the 5GC 50 in a case where disconnection of the N3 interface has been detected. Note that, in FIG. 17, messages to be transmitted and received are indicated by arrows. [NGAP], [NAS], and [RRC] shown at the beginning of each message indicate that the messages are an NGAP message, an NAS message, and an RRC message, respectively.

The control scheme of FIG. 17 is one example of a control scheme that avoids inefficient RRC Connection re-establishment. Further, carrying out extension of a UE Context Release Command, in addition to the addition of an RRC Release Complete, the extension of an RRC Release, and the extension of a UE Context Release Complete, is a prerequisite for the implementation of the control scheme of FIG. 17. Unlike the control scheme described above with reference to FIG. 6, the control scheme of FIG. 17 does not use a timer.

In step S361, the gNB 30 detects disconnection of the N3 interface. Note, here, that the gNB 30 detects disconnection of the N3 interface. As an example, in a control unit that controls execution of each process of the gNB 30, a detection unit that detects disconnection of the N3 interface by verifying a communication state between the gNB 30 and the UPF 51 is provided, so that disconnection of the N3 interface is detected by the detection unit.

In step S362, the gNB 30 transmits a UE Context Release Request to the 5GC 50, and, in step S561, the 5GC 50 receives the UE Context Release Request.

In this manner, in a case where disconnection of the N3 interface has been detected, the gNB 30 transmits, to the 5GC 50, the UE Context Release Request that is an NGAP message.

In step S562, the 5GC 50 transmits, to the gNB 30, a UE Context Release Command that is an NGAP message, and, in step S363, the gNB 30 receives the UE Context Release Command. Extending the UE Context Release Command as described above with reference to FIG. 15 enables an NAS message to be included in the UE Context Release Command. That is, the UE Context Release Command transmitted in step S562 includes the PDU Session Release Command as the NAS message.

In this manner, the gNB 30 receives the UE Context Release Command that is transmitted from the 5GC 50 as a response to the UE Context Release Request, the UE Context Release Command being the NGAP message including the PDU Session Release Command as the NAS message.

Since the processes in steps S364 to S367 of FIG. 17 are the same as the processes in steps S342 to S344 of FIG. 16, respectively, detailed descriptions thereof will not be repeated. Since the processes in steps S161 and S162 of FIG. 17 are the same as the processes in steps S141 and S142 of FIG. 16, respectively, detailed descriptions thereof will not be repeated. Since the processes in steps S562 and S563 of FIG. 17 are the same as the processes in steps S542 and S543 of FIG. 16, respectively, detailed descriptions thereof will not be repeated.

<Effect of Fourth Example Embodiment>

Thus, according to the present example embodiment, the base station apparatus 30 can detect disconnection of the N3 interface. In addition, it is possible to avoid inefficient RRC Connection re-establishment, and the number of messages transmitted and received before the DRB and the SRB are released can be reduced. Therefore, the DRB and the SRB can be released even more quickly, and a simpler control scheme can be realized.

### Fifth Example Embodiment

In the above-described example embodiment, an example in which the UE 10 transmits the RRC Release Complete as a response to the RRC Release having been transmitted from the gNB 30 has been described. Alternatively, the UE 10 may transmit the RRC Release Complete in a case where a PDU Session Release Command is included as an NAS message in an RRC Release having been transmitted from the gNB 30.

As described above with reference to FIG. 10, the dedicated NAS-Message of the part enclosed by the frame line 101 is described as Optional, and is an optionally inserted IE. Therefore, in some cases, the RRC Release transmitted from the gNB 30 does not include the PDU Session Release Command as the NAS message.

In the present example embodiment, whether the PDU Session Release Command is included as the NAS message in the RRC Release that the UE 10 has received from the gNB 30 is determined. Then, in a case where it has been determined that the PDU Session Release Command is included as the NAS message in the RRC Release, the UE 10 transmits, to the gNB 30, the RRC Release Complete including the PDU Session Release Complete as the NAS message.

In other words, in the present example embodiment, the UE does not have to transmit the RRC Release Complete in a case where the RRC Release does not include the PDU Session Release Command as the NAS message.

<Effect of Fifth Example Embodiment>

Thus, according to the present example embodiment, in a case where the RRC Release does not include the PDU Session Release Command as the NAS message, the UE 10 does not need to respond to the RRC Release. Therefore, it is possible to prevent the transmission and reception of excessive messages.

### Sixth Example Embodiment

In the above-described example embodiments, NAS messages are included in a UE Context Release Complete, an RRC Release Complete, and the like. These NAS messages do not need to be a PDU Session Release Complete at all times. For example, a Short Message Service (SMS) may be included as the NAS message in the UE Context Release Complete and the RRC Release Complete.

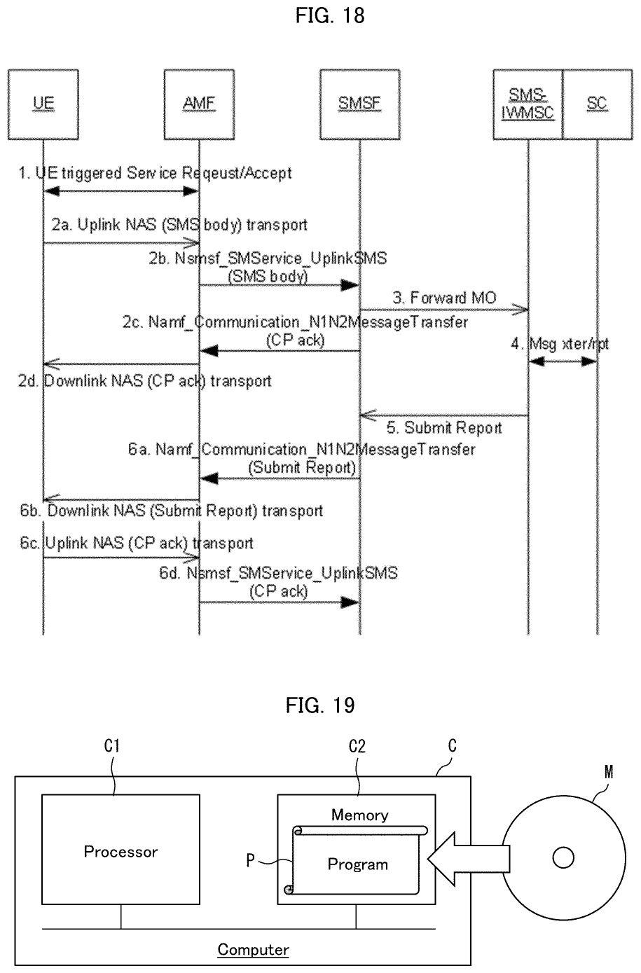

FIG. 18 is an arrow chart showing an SMS transmission scheme defined in 3GPP TS23.502 4.13.3.3 MO SMS over NAS in CM-IDLE (baseline). Thus, according to the definition of 3GPP TS23.502 4.13.3.3 MO SMS over NAS in CM-IDLE (baseline), an SMS can be carried on an NAS message.

The UE Context Release Complete, the RRC Release Complete, and the like may be caused to include an SMS as an NAS message. This makes it possible to efficiently transmit and receive an SMS.

### Other Example Embodiment

In the above-described example embodiments, the addition of an RRC Release Complete, the extension of an RRC Release, the extension of a UE Context Release Complete, and the extension of a UE Context Release Command are carried out. However, the addition or extension of these messages does not necessarily need to be valid for all apparatuses and components constituting the 5G system, but may be valid only for apparatuses and components that actually transmit and receive the above-described messages. In other words, the 3GPP standard does not necessarily need to be changed, and it is only required that apparatuses and components that actually transmit and receive the above-described messages are changed so as to be capable of addition or extension of each message.

In addition, according to the definition of 3GPP TS38.331 5.3.2.3 Reception of the Paging message by the UE, by transmitting a Paging message to the UE 10 in RRC_CONNECTED state, an RRC connection can be released to make a transition to an IDLE state.

As in the case of the extension of each message in above-described example embodiments, the Paging message may be extended so as to carry an NAS message, so that Deregister request is included as an NAS message in the Paging message transmitted to the UE 10 in RRC_CONNECTED state. This makes it possible to cause the UE 10 in communication to be transited to RRC_IDLE and Deregister at the same time.

Furthermore, although the above-described example embodiments have been described on the assumption that they are applied to a fifth generation mobile communication system (5G), it is also possible to apply to a fourth generation mobile communication system (4G) or a sixth generation mobile communication system (6G).

Software Implementation Example

The functions of part of or all of the apparatuses, including the terminal apparatus 10, the base station apparatus 30, and the apparatuses that constitute the 5GC 50 which are the UPF 51, the SMF 52, and the AMF 53, can be realized by hardware such as an integrated circuit (IC chip) or can be alternatively realized by software.

In the latter case, each of the apparatuses, including the terminal apparatus 10, the base station apparatus 30, and the apparatuses that constitute the 5GC 50 which are the UPF 51, the SMF 52, and the AMF 53, is realized by, for example, a computer that executes instructions of a program which is software realizing the foregoing functions. FIG. 19 illustrates an example of such a computer (hereinafter, referred to as “computer C”).

The computer C includes at least one processor C1 and at least one memory C2. The memory C2 stores a program P for causing the computer C to operate as the above-described apparatuses. In the computer C, the processor C1 reads the program P from the memory C2 and executes the program P, so that the functions of the apparatuses, including the terminal apparatus 10, the base station apparatus 30, and the apparatuses that constitute the 5GC 50 which are the UPF 51, the SMF 52, and the AMF 53.

As the processor C1, for example, it is possible to use a central processing unit (CPU), a graphic processing unit (GPU), a digital signal processor (DSP), a micro processing unit (MPU), a floating point number processing unit (FPU), a physics processing unit (PPU), a microcontroller, or a combination of these. The memory C2 can be, for example, a flash memory, a hard disk drive (HDD), a solid state drive (SSD), or a combination of these.

Note that the computer C can further include a random access memory (RAM) in which the program P is loaded when the program P is executed and in which various kinds of data are temporarily stored. The computer C can further include a communication interface for carrying out transmission and reception of data with other apparatuses. The computer C can further include an input-output interface for connecting input-output apparatuses such as a keyboard, a mouse, a display and a printer.

The program P can be stored in a non-transitory tangible storage medium M which is readable by the computer C. The storage medium M can be, for example, a tape, a disk, a card, a semiconductor memory, a programmable logic circuit, or the like. The computer C can obtain the program P via the storage medium M. The program P can be transmitted via a transmission medium. The transmission medium can be, for example, a communications network, a broadcast wave, or the like. The computer C can obtain the program P also via such a transmission medium.

Additional Remark 1

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

Additional Remark 2

Some of or all of the foregoing example embodiments can also be described as below. Note, however, that the present invention is not limited to the following example aspects.

(Supplementary Note 1)

A terminal apparatus including:
a reception means that receives a Radio Resource Control (RRC) Release that is an RRC message transmitted from a base station; and
a transmission means that transmits, to the base station, an RRC Release Complete as a response to the RRC Release,
the RRC Release Complete including, as a Non Access Stratum (NAS) message, a PDU Session Release Complete that is a response to a PDU Session Release Command which is included, as an NAS message, in the RRC Release.

(Supplementary Note 2)

The terminal apparatus according to supplementary note 1, further including:
a determination means that determines whether the PDU Session Release Command is included as the NAS message in the RRC Release having been received from the base station,
the transmission means transmitting the RRC Release Complete in a case where it has been determined by the determination means that the PDU Session Release Command is included as the NAS message.

(Supplementary Note 3)

The terminal apparatus according to supplementary note 1 or 2, wherein
the RRC Release which includes the PDU Session Release Command as the NAS message is transmitted from the base station in a case where disconnection of an N3 interface between the base station and a core network has been detected or in a case where disconnection of an N4 interface within the core network has been detected.

(Supplementary Note 4)

The terminal apparatus according to supplementary note 3, wherein
the RRC Release which includes the PDU Session Release Command as the NAS message is transmitted from the base station in a case where the PDU Session Release Command is included as the NAS message in a Next Generation Application Protocol (NGAP) message which is transmitted from the core network to the base station.

(Supplementary Note 5)

A communication method for a terminal apparatus that communicates with a base station, the communication method including:
receiving a Radio Resource Control (RRC) Release that is an RRC message transmitted from the base station; and
transmitting, to the base station, an RRC Release Complete as a response to the RRC Release,
the RRC Release Complete including, as a Non Access Stratum (NAS) message, a PDU Session Release Complete that is a response to a PDU Session Release Command which is included, as an NAS message, in the RRC Release.

(Supplementary Note 6)

A program causing a computer to function as a terminal apparatus, the terminal apparatus including:
a reception means that receives a Radio Resource Control (RRC) Release that is an RRC message transmitted from a base station; and
a transmission means that transmits, to the base station, an RRC Release Complete as a response to the RRC Release,
the RRC Release Complete including, as a Non Access Stratum (NAS) message, a PDU Session Release Complete that is a response to a PDU Session Release Command which is included, as an NAS message, in the RRC Release.

(Supplementary Note 7)

A base station apparatus including:
a reception means that receives a Next Generation Application Protocol (NGAP) message transmitted from a core network, the NGAP message including a PDU Session Release Command as a Non Access Stratum (NAS) message; and
a first transmission means that transmits, to the core network, a UE Context Release Complete that is the NGAP message, the UE Context Release Complete including, as the NAS message, the PDU Session Release Complete that has been received, as a response to the PDU Session Release Command, from a terminal apparatus.

(Supplementary Note 8)

The base station apparatus according to supplementary note 7, further including a second transmission means that transmits, to the terminal apparatus, a Radio Resource Control (RRC) Release that is an RRC message, the RRC Release including the PDU Session Release Command as an NAS message,
the first transmission means transmitting, to the core network, the UE Context Release Complete including the PDU Session Release Complete as the NAS message, in a case where an RRC Release Complete that is a response to the RRC Release has been received from the terminal apparatus, the RRC Release Complete including, as the NAS message, the PDU Session Release Complete that is a response to the PDU Session Release Command.

(Supplementary Note 9)

The base station apparatus according to supplementary note 7 or 8, wherein
the NGAP message including the PDU Session Release Command as the NAS message is a UE Context Release Command.

(Supplementary Note 10)

The base station apparatus according to supplementary note 8, wherein
the NGAP message including the PDU Session Release Command as the NAS message is a PDU Session Resource Release Command, and
the first transmission means transmits, to the terminal apparatus, the RRC Release including the PDU Session Release Command as the NAS message, in a case where a UE Context Release Command that is an NGAP message transmitted from the core network has been further received.

(Supplementary Note 11)

The base station apparatus according to any of supplementary notes 7 to 10, wherein
the NGAP message including the PDU Session Release Command as the NAS message is transmitted from the core network in a case where disconnection of an N3 interface between the base station and the core network has been detected or in a case where disconnection of an N4 interface within the core network has been detected.

(Supplementary Note 12)

The base station apparatus according to any of supplementary notes 7 to 10, further including:
a detection means that detects disconnection of an N3 interface between the base station and the core network; and
a third transmission means that, in a case where the detection means has detected disconnection of the N3 interface, transmits, to the core network, a UE Context Release Request that is an NGAP message,
the reception means receiving a UE Context Release Command that is transmitted, from the core network, as a response to the UE Context Release Request, the UE Context Release Command being the NGAP message including the PDU Session Release Command as the NAS message.

(Supplementary Note 13)

A communication method for a base station that communicates with a core network and a terminal apparatus, the communication method including:
receiving a Next Generation Application Protocol (NGAP) message transmitted from a core network, the NGAP message including a PDU Session Release Command as a Non Access Stratum (NAS) message; and
transmitting, to the core network, a UE Context Release Complete that is an NGAP message, the UE Context Release Complete including, as an NAS message, the PDU Session Release Complete that has been received, as a response to the PDU Session Release Command, from the terminal apparatus.

(Supplementary Note 14)

A program causing a computer to function as a base station apparatus, the base station apparatus including:
a reception means that receives a Next Generation Application Protocol (NGAP) message transmitted from a core network, the NGAP message including a PDU Session Release Command as a Non Access Stratum (NAS) message; and
a first transmission means that transmits, to the core network, a UE Context Release Complete that is an NGAP message, the UE Context Release Complete including, as an NAS message, the PDU Session Release Complete that has been received, as a response to the PDU Session Release Command, from a terminal apparatus.

(Supplementary Note 15)

A terminal apparatus including:
at least one processor, the at least one processor carrying out:
a process of receiving a Radio Resource Control (RRC) Release that is an RRC message transmitted from a base station; and
a process of transmitting, to the base station, an RRC Release Complete as a response to the RRC Release,
the RRC Release Complete including, as a Non Access Stratum (NAS) message, a PDU Session Release Complete that is a response to a PDU Session Release Command which is included, as an NAS message, in the RRC Release.

Note that the terminal apparatus can further include a memory. The memory can store a program for causing the processor to carry out the reception process and the transmission process. The program can be stored in a computer-readable non-transitory tangible storage medium.

(Supplementary Note 16)

A base station apparatus including:
at least one processor, the at least one processor carrying out:
a process of receiving a Next Generation Application Protocol (NGAP) message transmitted from a core network, the NGAP message including a PDU Session Release Command as a Non Access Stratum (NAS) message; and
a process of transmitting, to the core network, a UE Context Release Complete that is an NGAP message, the UE Context Release Complete including, as an NAS message, the PDU Session Release Complete that has been received, as a response to the PDU Session Release Command, from a terminal apparatus.

Note that the base station apparatus can further include a memory. The memory can store a program for causing the processor to carry out the reception process and the transmission process. The program can be stored in a computer-readable non-transitory tangible storage medium.

### REFERENCE SIGNS LIST

10: terminal apparatus
11: reception unit
12: transmission unit
30: base station apparatus
31: reception unit
32: first transmission unit
50: core network
51: UPF
52: SMF
53: AMF
60: DN

1. A terminal apparatus comprising:
at least one processor, the at least one processor carrying out:
a process of receiving a Radio Resource Control (RRC) Release that is an RRC message transmitted from a base station; and
a process of transmitting, to the base station, an RRC Release Complete as a response to the RRC Release,
the RRC Release Complete including, as a Non Access Stratum (NAS) message, a PDU Session Release Complete that is a response to a PDU Session Release Command which is included, as an NAS message, in the RRC Release.

2. The terminal apparatus according to claim 1, wherein
the at least one processor further carries out a process of determining whether the PDU Session Release Command is included as the NAS message in the RRC Release having been received from the base station, and
in the transmission process, the at least one processor transmits the RRC Release Complete in a case where it has been determined in the determination process that the PDU Session Release Command is included as the NAS message.

3. The terminal apparatus according to claim 1, wherein
the RRC Release which includes the PDU Session Release Command as the NAS message is transmitted from the base station in a case where disconnection of an N3 interface between the base station and a core network has been detected or in a case where disconnection of an N4 interface within the core network has been detected.

4. A communication method for a terminal apparatus that communicates with a base station, the communication method comprising:
receiving a Radio Resource Control (RRC) Release that is an RRC message transmitted from the base station; and
transmitting, to the base station, an RRC Release Complete as a response to the RRC Release,
the RRC Release Complete including, as a Non Access Stratum (NAS) message, a PDU Session Release Complete that is a response to a PDU Session Release Command which is included, as an NAS message, in the RRC Release.

5. A base station apparatus comprising:
at least one processor, the at least one processor carrying out:
a process of receiving a Next Generation Application Protocol (NGAP) message transmitted from a core network, the NGAP message including a PDU Session Release Command as a Non Access Stratum (NAS) message; and
a first transmission process of transmitting, to the core network, a UE Context Release Complete that is an NGAP message, the UE Context Release Complete including, as an NAS message, the PDU Session Release Complete that has been received, as a response to the PDU Session Release Command, from a terminal apparatus.

6. The base station apparatus according to claim 5, wherein
the at least one processor further carries out:
a second transmission process of transmitting, to the terminal apparatus, a Radio Resource Control (RRC) Release that is an RRC message, the RRC Release including the PDU Session Release Command as the NAS message, and
in the first transmission process, the at least one processor transmits, to the core network, the UE Context Release Complete including the PDU Session Release Complete as the NAS message, in a case where the at least one processor has received, from the terminal apparatus, an RRC Release Complete that is a response to the RRC Release, the RRC Release Complete including, as the NAS message, the PDU Session Release Complete that is a response to the PDU Session Release Command.

7. The base station apparatus according to claim 5, wherein
the NGAP message including the PDU Session Release Command as the NAS message is a UE Context Release Command.

8. The base station apparatus according to claim 6, wherein
the NGAP message including the PDU Session Release Command as the NAS message is a PDU Session Resource Release Command, and
in the first transmission process, the at least one processor transmits, to the terminal apparatus, the RRC Release including the PDU Session Release Command as the NAS message, in a case where the at least one processor has further received a UE Context Release Command that is an NGAP message transmitted from the core network.

9. The base station apparatus according to claim 7, wherein
the at least one processor further carries out:
a process of detecting disconnection of an N3 interface between the base station and the core network; and
a third transmission process of, in a case where the disconnection of the N3 interface has been detected in the detection process, transmitting, to the core network, a UE Context Release Request that is an NGAP message,
in the reception process, the at least one processor receiving the UE Context Release Command that is transmitted from the core network as a response to the UE Context Release Request, the UE Context Release Command being the NGAP message including the PDU Session Release Command as the NAS message.
